(19) United States
(12) Patent Application Publication
(10) Pub. No.: US 2004/0266341 A1
(43) Pub. Date: Dec. 30, 2004

(54) Method of transmitting postion data from a mobile unit

(76) Inventor: Iain Teunon, Leatherhead (GB)

Correspondence Address: JACOBSON HOLMAN PLLC, 400 SEVENTH STREET N.W., SUITE 600, WASHINGTON, DC, 20004, US

(21) Appl. No.: 10/478,297

(22) PCT Filed: May 30, 2002
(86) PCT No.: PCT/GB02/02281

(30) Foreign Application Priority Data
May 31, 2001 (GB) 01131499

(51) Int. Cl. H04Q 7/20; H04B 7/185

(52) U.S. Cl. 455/12.1; 455/456.1; 455/427

(57) ABSTRACT

A method of transmitting position data from a mobile unit comprises determining a coordinate position of the mobile unit and transmitting position data in two messages spaced in time one message having higher order data truncated and the other having lower order data truncated whereby both messages can be transmitted over a lower bandwidth and the position data can be reconstructed at a receiving station from the two messages.

The e present invention relates to a method of transmitting position data from a mobile unit and has particular, but not exclusive, application to automatic vehicle location (AVL), automatic person location (APL) and asset tracking systems. There are many occasions when knowing the location of a vehicle, a person or an asset is of utmost importance, for example, a policeman in a dangerous situation, an ambulance en route to an emergency or a stolen vehicle. The availability of accurate, relatively low cost satellite positioning receivers has solved the problem of location, but there remains the difficulty of transmitting this location to a control centre regularly and frequently. Generally public safety vehicles and individual officers carry two-way radios, and an option would be to use them to send the location. However, it is essential that this does not disrupt the voice and data communications for which the radios are intended. There is therefore a conflict between this requirement to minimise disruption and the requirement to send frequent, accurate locations.

The International Civil Aviation Organization (ICAO) has published, see Manual on Mode S Specific Services (Doc 9688-AN/952), an algorithm which compresses location data to be sent via an aircraft's SSR transponder. However, the algorithm is optimised for use by aircraft anywhere in the world and so is unnecessarily complicated for ground use, using more bits than are necessary, and is liable to give erroneous positions under certain circumstances.

An object of the invention is to facilitate the efficient transmission of data, such as position location data, over a communications channel whilst requiring a reduced bandwidth, thus, for example, allowing the communication channel also to carry other signals.

The invention accordingly provides a method of transmitting from a mobile unit position data derived from a grid coordinate system and defining unambiguously to a desired resolution a position of said unit within said coordinate system, wherein said position data is transmitted in the form of two messages spaced in time, one message comprising coordinate position data from which a lower order of data has been truncated whereby the one message defines an unambiguous position within said coordinate system at a resolution lower than said desired resolution, and the other message comprising coordinate position data from which a higher order of data has been indicated whereby the other message defines to the said desired resolution a position within said coordinate system that is ambiguous, the degree of truncation of the position data in each message being determined in accordance with a predetermined factor corresponding to a given distance within said coordinate system that is greater than the distance travelled by said mobile unit in the time space between said messages, whereby from the data of the two transmitted messages and the said predetermined factor, the position of the unit at the time of transmission of the said other message can be determined to said desired resolution.

This has the advantage of occupying a lower radio spectrum to convey the defined position information. Looked at in another way, if the radio channel is shared with other data or voice transfer applications, the load on the channel and hence the disruption caused to other communications is minimised, without compromising either position resolution or ambiguity. ICAO uses 34 bits to convey accurate position information to air traffic control (5.1 metres resolution with an ambiguity of 666 km for airborne use, 1.2 metres with an ambiguity of 166 km for surface use). Use of the proposed compression algorithm would achieve improved performance with 32 bits. Similarly since public safety communications in Europe are migrating to a digital private mobile radio standard known as TErrestrial trunked RAdio (TETRA), details of which can be obtained from ETSI web page www.etsi.org, a typical objective is to keep the message length below 32 bits so that it can be carried by a single TETRA SDS 2 short data message, which will achieve the requirement to cause minimum disruption to ongoing speech communications. Other applications are known which are prepared to accept lower location resolution. For example 16 bits to convey approximate resolution is sometimes acceptable. The method of the present invention allows an optimised trade-off to be made between location accuracy and data message length.

This invention could also be used to reduce the amount of data storage required to maintain a log of the trick of a vehicle, with applications in the transportation of high value or hazardous cargoes.

Further preferred features and advantages of the invention will become apparent from the following description taken in conjunction with the subordinate claims,

The present invention will now be described, by way of example, with reference to the accompanying drawings, wherein:

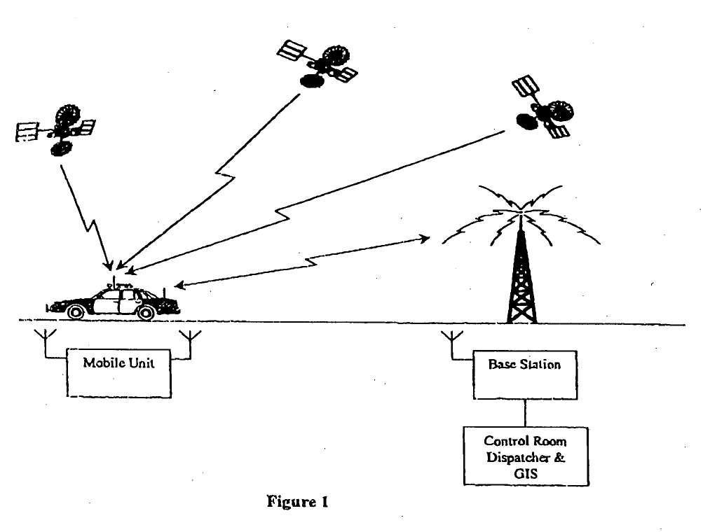

FIG. 1 is a schematic of an example of an AVI system.

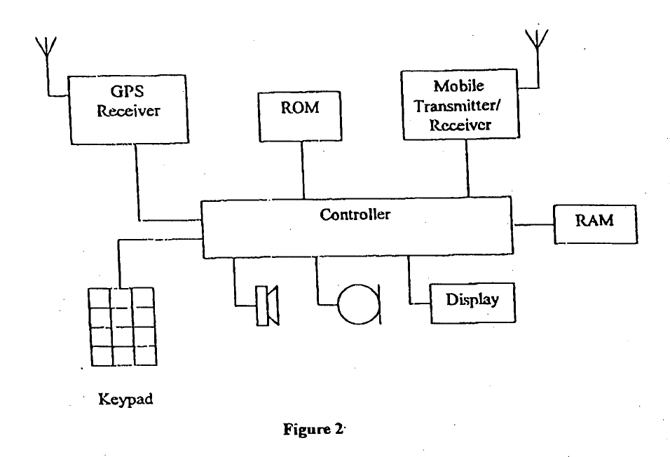

FIG. 2 is a schematic of a mobile unit of the system of FIG. 1, and

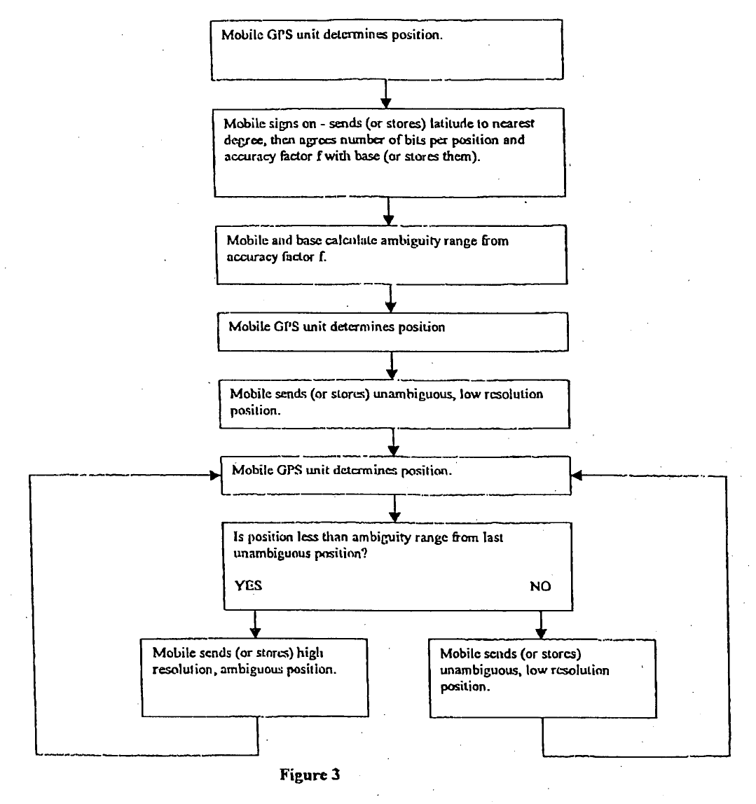

FIG. 3 is a flow chart showing an example or the method of the invention.

To achieve a resolution of 1 metre over the entire surface of the globe would require 24 bits for latitude and 25 bits for longitude, making a total of 49 bits which is outside the 32 bit target. Truncating the position to 32 bits by representing latitude and longitude each by 16 bits would either reduce the resolution to 610 metres, or reduce the unambiguous area to 35×35 nautical miles, requiring 120,000 squares to cover the globe. A resolution of 610 metres is of little use, while 120,000 separate areas would require extra transmissions to determine which area the radio was in.

An algorithm which enables latitude and longitude to be expressed with the desired resolution will now be described. Essentially the algorithm fulfils this objective by varying between truncating the most significant and least significant bits of the location data. The locations sent are then either high resolution but ambiguous positions, or low resolution but unambiguous positions. Unlike the ICAO algorithm, this algorithm is extremely robust and, subject to the update conditions given below (and highlighted in FIG. 3), always gives the correct position, and it requires less bits. It will only give a wrong position if the radio travels too far between reporting unambiguous positions, when it will put the radio in the wrong zone. The algorithm contains a factor f which enables a trade off between resolution and the distance a radio can travel between reporting unambiguous positions.

An example procedure for using the invention is shown in FIG. 3. The associated worked example shows all the calculations performed to encode the sent data and decode the received data. The inherent errors introduced by the process are calculated to illustrate the accuracy that can be achieved.

The algorithm is as follows:

Latitude encoding

Latitude=lat

No. of bits=n

Factor=f

Unambiguous position

latscale=lat+90

latitude runs from −90 (South pole) to +90 (North pole), so latscale runs from 0 (South pole) to 180 (North pole), i.e. always positive

latcode=−latscale/180

latcode runs from 0 (South pole) to −1 (North pole)

latsend=latcode*2ⁿ, rounded to the nearest integer

latcode runs from 0 (South pole) to −2ⁿ (North pole)

latsend is transmitted as a signed binary number

High resolution position

latscale=lat+90

latcode=latscale*f mod 1 (only retain decimal fraction)

by increasing f you trade resolution and ambiguity, so that increasing f from 1 to 2 will double the resolution, but halve the ambiguity from 1° (111 km) to 0.5° (55.5 km)

latsend=latcode*2ⁿ, rounded to the nearest integer

latsend is transmitted as a signed binary number

Latitude decoding

Received binary number=latreceive latcode=latreceive/2ⁿ

If latcode is negative it represents an unambiguous position, if positive, a high resolution position

Unambiguous position

latscale=latcode*180

latzone=floor (latscale, 1/f)

unambiguous latitude=latscale−90

High resolution position

inc=latcode/f−last unambiguous latscale mod 1/f

if abs (inc<0.5/f) then latscale=latzone+latcode/f

else latscale=latzone+latcode/f−sign (inc)/f

this covers the case where a mobile crosses an ambiguity boundary, for example from 53.99° to 54.01°

high resolution latitude=latscale−90

Longitude encoding

Longitude=long

No. of bits=n

Factor=f

Longitude factor=lf=cos (start latitude) (this only needs to be sent once)

This is to allow for the lines of longitude gelling closer nearer the poles so that resolution of latitude and longitude is equalised

Unambiguous position

longscale=long*lf

longcode=−longscale/360

longcode runs from 0 to −lf

longsend=longcode*2ⁿ, rounded to the nearest integer

longsend runs from 0 to −lf*2ⁿ

longsend is transmitted as a signed binary number

High resolution position

if abs (long−last unambiguous long)<180 then longscale=long*lf

else longscale=(long−360*sign (long−last unambiguous long))*lf

this covers the care where the mobile crosses the Greenwich meridian, i.c. 0°

longcode=longscale*f mod 1 (only retain decimal fraction)

longsend=longcode*2ⁿ, rounded to the nearest integer

longsend is transmitted as a signed binary number

Longitude decoding

Received binary number=longsend

longcode=longsend/2ⁿ

If longcode is negative it represents an unambiguous position, if positive, a high resolution position

Unambiguous position

longscale=−longcode*360

longzone=floor (longscale, 1/f)

unambiguous longitude=longscale/lf mod 360

High resolution position

inc=longcode/f−last unambiguous longscale mod 1/f

if abs (inc<0.5/f) then longscale=longzone+longcode/f

else longscale=longzone+longcode/f−sign (inc)/f

again, like latitude, this covers the case where a mobile crosses an ambiguity boundary, for example from 0.99° to 1.01°

high resolution longitude=longscale/lf mod 360

| | Distance travelled from | | | | |
|---|---|---|---|---|---|
| | last reported | | | | |
| Factor | unambiguous position - | Bits per message | | | |
| f | metres | 26 | 28 | 30 | 32 |
| 1 | 55,590 | 13.57 | 6.79 | 3.39 | 1.70 |
| 2 | 27,795 | 6.79 | 3.39 | 1.70 | 0.85 |
| 3 | 18,530 | 4.52 | 2.26 | 1.13 | 0.57 |
| 4 | 13,897 | 3.39 | 1.70 | 0.85 | 0.42 |
| 5 | 11,118 | 2.71 | 1.36 | 0.68 | 0.34 |
| 6 | 9,265 | 2.26 | 1.13 | 0.57 | 0.28 |
| 7 | 7,941 | 1.94 | 0.97 | 0.48 | 0.24 |
| 8 | 6,949 | 1.7 | 0.85 | 0.42 | 0.21 |
| 9 | 6,177 | 1.51 | 0.75 | 0.38 | 0.19 |
| 10 | 5,559 | 1.36 | 0.68 | 0.34 | 0.17 |

Resolution - metres

The table shows the trade off between resolution and distance travelled since the last reported unambiguous position, determined by the factor f in the algorithm. For example, providing that the mobile does not travel more than 27.795 km between fixes, 32 bit messages will give a resolution of 0.85 metres.

The above algorithm will now be further illustrated with a specific numeric example applicable to the flow chart shown in FIG. 3. For simplicity tire example shown below comprises only the calculations required to encode the two messages required to define a single coordinate position, and does not include calculations relating to the method steps involving, a decision as to whether a high resolution or low resolution message is to be sent. It will however be clearly apparent to one skilled in the art how the ambiguity range may be calculated from any given factor f and how it can be determined whether the difference between two consecutive measured positions is within this range

### EXAMPLE

Start position 0.58108° W; 51.23333° N. Longitude is converted to 359.41892° E.

Mobile sign-on sequence:

send latitude to nearest degree=51

send number of bits=32 (15 bits+sign each for latitude and longitude)

send factor f=2 (the factor f is preferably calculated or predetermined to allow for the speed of movement of the mobile unit)

Unambiguous latitude

lat=51.23333

latscale=lat+90=141.23333

latcode=−latscale/180=−0.78462961

latsend=latcode*2¹⁵, rounded to nearest integer=−25711

latreceive=latsend=−25711

latcode=latreceive/2¹⁵=−0.78463745

latscale=−latcode*180=141.2347412

latzone=floor (latscale, 1/f)=floor (141.2347412, 0.5)=141

lat=latscale−90=51.23474121

error=(51.23474121−51.23333)*60*1853=156.9 metres

High resolution latitude

move 25.6 km North

lat=51.23333+26500/(1853*60)=51.46358724

latscale=lat+90 141.4635872

latcode=latscale*f mod 1=0.927174481

latsend=latcode*2¹⁵, rounded to nearest integer=30382

latreceive=latsend=30382

latcode=latreceive/2¹⁵=0.927185059

inc=latcode/f−last unambiguous latscale mod 1/f=0.228851318

abs (inc<0.5/f) so latscale=latzone+latcode/f=141.4635925

lat=latscale −90=51.46359253

error=(51.46359253−51.46358724)*60*1853=0.59 metres

Unambiguous longitude

longitude factor (lf)=cos(latitude to nearest degree)=cos(51)=0.629320391

long=359.41892

longscale=long*lf=226.1896553

longcode=longscale/360=−0.6283046

longsend=longcode*2¹⁵, rounded to nearest integer=−20598

longreceive=longsend=−20588

longcode=longreceive/2¹⁵=−0.6282959

longscale=−longcode*360=226.1865234

longzone=floor (longscale, 1/f)=floor (226.1865234, 0.5)=226

long=longscale/lf=359.4139434

error=(359.4139434−359.41892)*60*1853 lf=−348.2 metres

High resolution longitude

move 25.6 km Fast

long=359.41892+26500/(1853*60*lf)=359.7848024

abs (long−last unambiguous long)<180 so longscale=long*lf=141.4635872

longcode=longscale*f mod 1=0.839825051

longsend=longcode*2¹⁵, rounded to nearest integer=27519

longreceive=longsend=27519

longcode=longreceive/2¹⁵=0.839813232

inc=longcode/f−last unambiguous longscale mod 1/f=0.233383179

abs (inc<0.5/f) so longscale=longzone+longcode/f=226.4199066

long=longscale/lf mod 360=359.784793

error=(359.784793−359.7848024)*60*1853 *lf=−0.66 metres

1. A method of transmitting from a mobile unit position data derived from a grid coordinate system and defining unambiguously to a desired resolution a position of said unit within said coordinate system, wherein said position data is transmitted in the form of two messages spaced in time, one message comprising coordinate position data from which a lower order of data has been truncated whereby the one message defines an unambiguous position within said coordinate system at a resolution lower than said desired resolution, and the other message comprising coordinate position data from which a higher order of data has been truncated whereby the other message defines to the said desired resolution a position within said coordinate system that is ambiguous, the degree of truncation of the position data in each message being determined in accordance with a predetermined factor corresponding to a given distance within said coordinate system that is greater than the distance travelled by said mobile unit in the time space between said messages, whereby from the data of the two transmitted messages and the said predetermined factor, the position of the unit at the time of transmission of the said other message can be determined to said desired resolution.

2. A method according to claim 1, wherein the said predetermined factor is determined by a receiving station from a transmitted message sent from said mobile unit prior to transmission of said two messages.

3. A method according to claim 1, wherein said messages are encoded in digital form, and the number of data bits comprised in each of said two messages is determined by a receiving station from a transmitted message sent from said mobile unit prior to transmission of said two messages.

4. A method according to claim 1, wherein said grid coordinate system is the system of latitude and longitude, the longitude coordinate is encoded in each of said two messages utilising a second factor derived from a latitude coordinate, and wherein said latitude coordinate is transmitted in a message sent from said mobile unit to a receiving station prior to transmission of said two messages.

5. A method according to claim 1, wherein said mobile unit is arranged to determine its position in said coordinate system by means of a global positioning system.

6. A method according to claim 1, wherein said mobile unit is programmed to send said one message before said other message.

7. A method according to claim 6, wherein said mobile unit is programmed to determine its position prior to transmission of each of said two messages, to determine the distance between the respective two positions at the points in time corresponding to the times at which the messages are to be transmitted, and, if said distance exceeds the said given distance to transmit instead of said other message, a new one message deeming a new unambiguous position.

8. A method according to claim 1, wherein the said two messages are transmitted as signed numbers and the sign of the number distinguishes the one or the other message.

9. A method according to claim 4, wherein the unambiguous latitude position is transmitted as a signed binary number in the form:
−[(lat+90)/180]*2ⁿ, rounded to the nearest integer, where lat=the latitude coordinate to the desired resolution and n=the number of bits in the digital message.

10. A method according to claim 9, wherein the ambiguous latitude position is transmitted as a signed binary number in the form: −[(lat+90)×f mod l (only retain decimal fraction)]×2ⁿ, rounded to the nearest integer where f=the said predetermined factor.

11. A method according to claim 9, wherein said unambiguous longitude position is transmitted as a signed binary number in the form:
−[(long×lf/360]×2ⁿ, rounded to the nearest integer where long=the longitude coordinate to said desired resolution, and lf=the said second factor.

12. A method according to claim 11, wherein the said ambiguous longitude position is transmitted as a signed binary number in the form: [{long (if abs(long-last unambiguous long)<180 else (long−360×sign(long-last unambiguous long)}×lf]×f mod l (only retain decimal fraction)×2ₙ, rounded to the nearest integer
where f=the said predetermined factor.
